(19) United States
(12) Patent Application Publication
(10) Pub. No.: US 2026/0018180 A1
(43) Pub. Date: Jan. 15, 2026

(54) AUDIO DATA PROCESSING METHOD, APPARATUS, SYSTEM AND ELECTRONIC DEVICE

(71) Applicant: Beijing Zitiao Network Technology Co., Ltd., Beijing (CN)

(72) Inventors: Dongpo Li, Beijing (CN); Meng Xu, Beijing (CN); Peng Hao, Beijing (CN)

(21) Appl. No.: 19/044,909

(22) Filed: Feb. 4, 2025

(30) Foreign Application Priority Data
Jul. 10, 2024 (CN) 202410925812.0

(51) Int. Cl. G10L 19/02

(52) U.S. Cl. CPC G10L 19/02

(57) ABSTRACT

Embodiments of the present disclosure provide an audio data processing method, apparatus and system, and an electronic device. The method is applied to a first terminal and comprises: acquiring first audio data; determining a target compression parameter according to target type information corresponding to the first audio data, and compressing the first audio data based on the target compression parameter to obtain first compressed data; wherein the target type information comprises a speech type or a non-speech type; transmitting the first compressed data to a second terminal, wherein the first terminal and the second terminal are wirelessly connected via Bluetooth.

### CROSS-REFERENCE TO RELATED APPLICATION(S)

This application claims priority to Chinese Application No. 202410925812.0 filed Jul. 10, 2024, the disclosure of which is incorporated herein by reference in its entirety.

### FIELD

Embodiments of the present disclosure relate to the field of computer and network communication technologies, and particularly, to an audio data processing method, an apparatus, a system, and an electronic device.

### BACKGROUND

A short-distance wireless connection between different devices may be achieved using Bluetooth technology. The Bluetooth technology provides various Bluetooth audio transmission specifications, such as Bluetooth stereo audio transmission specification (Advanced Audio Distribution Profile, A2DP) which defines a high-quality (stereo or mono) wireless transmission method, or a specification of a remote control audio or video device (Audio/Video Remote Control Profile, AVRCP) such as play, pause and volume control etc.

### SUMMARY

Embodiments of the present disclosure provide an audio data processing method, apparatus and system, and an electronic device.

In a first aspect, an embodiment of the present disclosure provides an audio data processing method applied to a first terminal, the method comprising: acquiring first audio data; determining a target compression parameter according to target type information corresponding to the first audio data, and compressing the first audio data based on the target compression parameter to obtain first compressed data; wherein the target type information comprises a speech type or a non-speech type; transmitting the first compressed data to a second terminal, wherein the first terminal and the second terminal are wirelessly connected via Bluetooth.

In a second aspect, an embodiment of the present disclosure provides an audio data processing method applied to a second terminal, the method comprising: acquiring first transmission data from a first terminal, wherein the second terminal and the first terminal are wirelessly connected via Bluetooth; decompressing first compressed data in the first transmission data based on compression parameter information indicating a target compression parameter in the first transmission data to obtain second audio data, wherein the first compressed data is obtained by compressing first audio data using the target compression parameter.

In a third aspect, an embodiment of the present disclosure provides an audio data processing apparatus provided in a first terminal, the apparatus comprising: a first acquisition unit configured to acquire first audio data; a compression unit configured to determine a target compression parameter according to target type information corresponding to the first audio data, and compressing the first audio data based on the target compression parameter to obtain first compressed data; wherein the target type information comprises a speech type or a non-speech type; a sending unit configured to send the first compressed data to a second terminal, wherein the first terminal and the second terminal are wirelessly connected via Bluetooth.

In a fourth aspect, an embodiment of the present disclosure provides an audio data processing apparatus provided in a second terminal, the apparatus comprising: a second acquisition unit configured to acquire first transmission data from a first terminal, wherein the second terminal and the first terminal are wirelessly connected via Bluetooth; a decompression unit configured to decompress first compressed data in the first transmission data based on compression parameter information indicating a target compression parameter in the first transmission data to obtain second audio data.

In a fifth aspect, an embodiment of the present disclosure provides an audio data processing system comprising a first terminal and a second terminal; the first terminal and the second terminal are wirelessly connected via Bluetooth; the first terminal comprises a data acquisition device, a data processing device and a first Bluetooth device, wherein the data acquisition device acquires first audio data; the data processing device determines a target compression parameter according to target type information corresponding to the first audio data, and compresses the first audio data based on the target compression parameter to obtain first compressed data; wherein the target type information comprises a speech type or a non-speech type; the first Bluetooth device sends the first compressed data to the second terminal; the second terminal comprises a second Bluetooth device and a second data processing device, and the second Bluetooth device acquires first transmission data from the first terminal; the second data processing device decompresses the first compressed data in the first transmission data based on compression parameter information indicating the target compression parameter in the first transmission data to obtain second audio data.

In a sixth aspect, an embodiment of the present disclosure provides an electronic device comprising: a processor and a memory;
the memory stores computer-executable instructions;
the processor executes the computer-executable instructions stored in the memory to cause the at least one processor to implement the methods in the first aspect, the second aspect and various possible designs of the first aspect and second aspect.

In a seventh aspect, an embodiment of the present disclosure provides a computer-readable storage medium having stored therein computer-executable instructions that, when executed by a processor, implement the methods in the first aspect, the second aspect, and various possible designs of the first aspect and the second aspect.

In an eighth aspect, an embodiment of the present disclosure provides a computer program product comprising a computer program which, when executed by a processor, implement the methods in the first aspect, the second aspect, and various possible designs of the first aspect and the second aspect.

### BRIEF DESCRIPTION OF THE DRAWINGS

In order to illustrate embodiments of the present disclosure or technical solutions in the prior art more clearly, a brief introduction will be given below to accompanying drawings to be used in describing the embodiments or the prior art; it is obvious that the drawings in the following depictions are some embodiments of the present disclosure, and those having ordinary skill in the art may also obtain other drawings according to these drawings without making any inventive efforts.

FIG. 1 illustrates a first flow chart of an audio data processing method according to an embodiment of the present disclosure;

FIG. 2 illustrates a second flow chart of an audio data processing method according to an embodiment of the present disclosure;

FIG. 3 illustrates a third flow chart of an audio data processing method according to an embodiment of the present disclosure;

FIG. 4 illustrates a flow chart of an audio data processing method according to an embodiment of the present disclosure;

FIG. 5 illustrates a schematic diagram of an audio data processing apparatus according to an embodiment of the present disclosure;

FIG. 6 illustrates a schematic diagram of an audio data processing apparatus according to an embodiment of the present disclosure;

FIG. 7 is a schematic diagram of an audio data processing system according to an embodiment of the present disclosure;

FIG. 8 is a schematic diagram of an electronic device according to an embodiment of the present disclosure.

### DETAILED DESCRIPTION OF EMBODIMENTS

To make objectives, technical solutions and advantages of embodiments of the present disclosure more apparent, the technical solutions in embodiments of the present disclosure will be described clearly and completely with reference to figures in embodiments of the present disclosure. Obviously, the embodiments described herein are partial embodiments rather than all embodiments of the present disclosure. Based on the embodiments in the present disclosure, all other embodiments obtained by those having ordinary skill in the art without making any inventive efforts all fall within the extent of protection of the present disclosure.

As mentioned above, the Bluetooth technology provides various Bluetooth audio transmission specifications. However, these specifications have certain limitations such as sound quality limitations, coding limitations, bandwidth limitations, etc. In addition, compression algorithms used in the above standard specifications cause a large amount of data resulting from the compression.

Data transmission may be performed between devices supporting the Bluetooth wireless communication technology, for example, audio data may be transmitted between a mobile terminal and a Bluetooth headset. The Bluetooth headset may collect an audio signal, transmit the collected audio signal to the mobile terminal, etc. The collected audio data is usually compressed before the Bluetooth headset transmits the audio data to the mobile terminal. In one embodiment, the audio signals to be transmitted may be compressed and transmitted using a standard specification provided by Bluetooth technology. However, in a compression scheme provided in the above standard specification, the compression parameter is fixed, and both a speech signal and a non-speech signal need to be compressed using a preset compression parameter. Generally, a compression parameter with better speech signal restoration quality need to be used to compress the audio in order to ensure the quality after the speech signal is restored. Therefore, the amount of compressed data obtained by compressing the audio data is larger, and a larger data transmission bandwidth is occupied to transmit the compressed data, which does not facilitate fast transmission of the audio data between different devices.

In order to solve one of the above problems, the present disclosure may determine a target compression parameter according to target type information of the acquired first audio data, and then compress the audio data according to the target compression parameters, so as to adopt different target compression parameters for speech-type and non-speech type audio signals, which helps reduce the amount of data of the total compressed audio data on the premise of ensuring that the speech signal has a small loss, and helps achieve fast transmission of the audio data between different devices. In other words, since different target compression parameters are employed for the speech-type and non-speech-type audio signals, the present disclosure helps reduce the amount of data of the compressed audio data on the premise of ensuring that the speech signal has a small loss, and helps achieve fast transmission of the audio data between different devices.

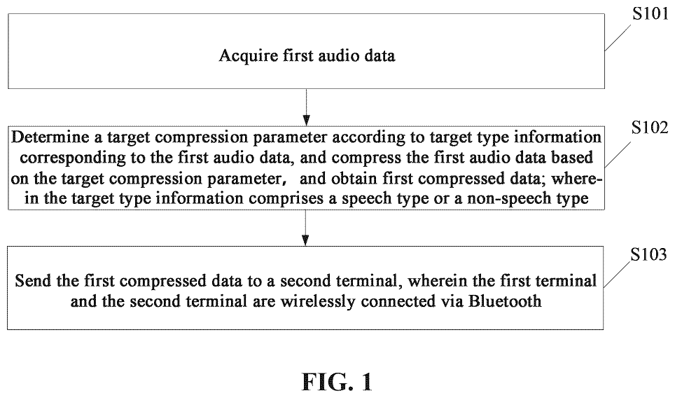

Referring to FIG. 1, FIG. 1 illustrates a first flow chart of an audio data processing method according to an embodiment of the present disclosure. The method according to the present embodiment may be applied to a first terminal. The audio data processing method comprises:
S101: acquiring first audio data.

The above first terminal may be any terminal device supporting Bluetooth technology, and a Bluetooth device may be provided in the first terminal device. The first terminal may be wirelessly connected to other terminal devices supporting Bluetooth technology via Bluetooth.

Illustratively, the first terminal may be a wearable device such as a headset, smart glasses, smart bracelets, smart watches. In addition, the wearable device may be provided with a processor for processing audio data, audio data processing algorithms may be run in the processor, and these algorithms may for example comprise an audio classification algorithm, an audio data compression algorithm, etc.

In some embodiments, the first terminal may be provided with an audio signal acquisition device such as a microphone. The audio signal acquisition device may periodically acquire an audio signal, convert the acquired audio signal into an analogue electrical signal, and then sample and quantify the analogue electrical signal to obtain first audio data.
S102: determining a target compression parameter according to target type information corresponding to the first audio data, and compressing the first audio data based on the target compression parameter to obtain first compressed data; wherein the target type information comprises a speech type or a non-speech type.

The above first terminal may parse the type of the first audio data to obtain the target type information. For each of the first audio data, the target type information of the first audio data indicates that the first audio data is in the speech type or indicates that the first audio data is in the non-speech type.

In some embodiments, the speech type comprises a human speech, such as a speech emitted by a user using the first terminal, and the non-speech type comprises an ambient sound.

The ambient sound may be other sounds other than the human speech, such as sound from musical instruments, background music, ambient noise, etc.

In some embodiments, the audio data processing method further comprises the following steps:
firstly, classifying the first audio data based on a preset audio classification algorithm.
secondly, determining the target type information of the first audio data according to a classification result.

In these embodiments, a preset audio classification algorithm may be provided in the first terminal to classify the first audio data.

Illustratively, the preset audio classification algorithm may determine a spectrogram of the first audio data, and then determine the type of the first audio data according to the spectrogram and pre-acquired spectral information corresponding to different types of speech, respectively. For example, human speech audio is usually distributed over a range of frequencies (e.g., 500 Hz to 4 KHz), and a non-speech signal (e.g., ambient sound) might cover a wider frequency range. If the spectrogram of the first audio data falls within a frequency band corresponding to the speech audio, the classification result of the first audio data is the speech type. If the spectrogram of the first audio data covers a wider frequency range, the classification result of the first audio data may be considered as the non-speech type.

For another example, the above preset speech classification algorithm may also count a zero-crossing rate of the first audio data, and whether the first audio data is a speech signal or a non-speech signal is judged according to the zero crossing rate. The zero crossing rate is the number of signal crossings from positive to negative, or from negative to positive. Generally, the non-speech signal has a high zero crossing rate and the speech signal has a low zero crossing rate. If the zero crossing rate of the first audio data is greater than a preset zero crossing rate threshold, the classification result corresponding to the first audio data is the non-speech type, otherwise, the classification result corresponding to the first audio data is the speech type.

As another example, the preset speech classification algorithm may also include a pre-trained machine learning algorithm. The features of the first audio data are extracted by the machine learning algorithm and then the first audio data is classified according to the features of the first audio data. The features of the first audio data comprise one or more of spectral features, time domain features, and harmonic features. The spectral features include, but not limited to Mel-frequency cepstrum coefficients, linear predictive coding, spectral center point, spectral bandwidth, etc. The time domain features include, but are not limited to: zero crossing rate, energy, entropy, etc. The harmonic features: The speech-type audio data typically has a pronounced harmonic structure, whereas the non-speech-type audio data may not have a pronounced harmonic structure.

In these implementations, with the preset speech classification algorithm being set in the first terminal, fast classification of the first audio data may be achieved to obtain the target type information corresponding to the first audio data.

Here, the target compression parameter may comprise a compression ratio. The compression ratio refers to a ratio of a size of the compressed data to a size of the raw data, generally expressed as a percentage. If the original size of the audio data is 100 MB and the size of the compressed audio data is 50 MB, the compression ratio is 50%. The larger the compression ratio is, the smaller the size of the compressed audio data is. However, if the compression ratio is too large, the loss of the audio data is large, and the distortion of the audio data restored from the compressed data is large.

In some embodiments, the compression ratio corresponding to the speech-type audio data is smaller than that corresponding to the non-speech type audio data.

It is assumed that the speech-type audio data corresponds to a first compression ratio, and the non-speech type audio data corresponds to a second compression ratio.

If the first audio data is the speech-type audio data, the first audio data is compressed using the first compression ratio. If the first audio data is the non-speech type audio data, the first audio data is compressed using the second compression ratio. That is to say, for the non-speech type audio data and speech-type audio data with the same size, due to different compression ratios, the size of the first compressed data obtained after the non-speech type audio data is compressed is smaller, and the size of the first compressed data obtained after the speech-type audio data is compressed is larger. That is, in the audio data stream, the audio data is compressed using the first compression ratio, and the non-audio data is compressed using the second compression ratio. The second compression ratio is greater than the first compression ratio. Therefore, the amount of data of the compressed data transmitted from the first terminal to the second terminal may be reduced, the bandwidth for data transmission may be reduced, which helps enable fast transmission of the audio data from the first terminal to the second terminal.
S103: transmitting the first compressed data to a second terminal, wherein the first terminal and the second terminal are wirelessly connected via Bluetooth.

In the present embodiment, the second terminal may be any terminal used by the user and supporting the Bluetooth technology. In some embodiments, the second terminal may be a mobile terminal, such as a mobile phone, a notebook computer, a Pad, etc.

The data interaction may be achieved between the first terminal and the second terminal via a Bluetooth wireless connection. The first terminal may transmit the first compressed data to the second terminal via the Bluetooth wireless connection. That is, the first terminal compresses the acquired first audio data and then transmits the compressed first audio data to the second terminal. The second terminal may decompress the above-mentioned first compressed data to obtain decompressed second audio data.

In the present embodiment, the first terminal determines the target type information of the acquired first audio data, determines the target compression parameter according to the speech type or the non-speech type indicated by the target type information, compresses the first audio data based on the compression parameter to obtain the first compressed data, and sends the first compressed data to the second terminal wirelessly connected to the first terminal via Bluetooth. Therefore, for an audio data stream, when audio data sampled from the audio data stream at different sampling periods is compressed and transmitted, the compression parameters vary with different types of audio data. Compressing the speech-type and non-speech type audio data using different target compression parameters helps reduce the amount of data of the total compressed audio data on the premise of ensuring that the speech signal has a small loss, and helps achieve fast transmission of the audio data between different devices.

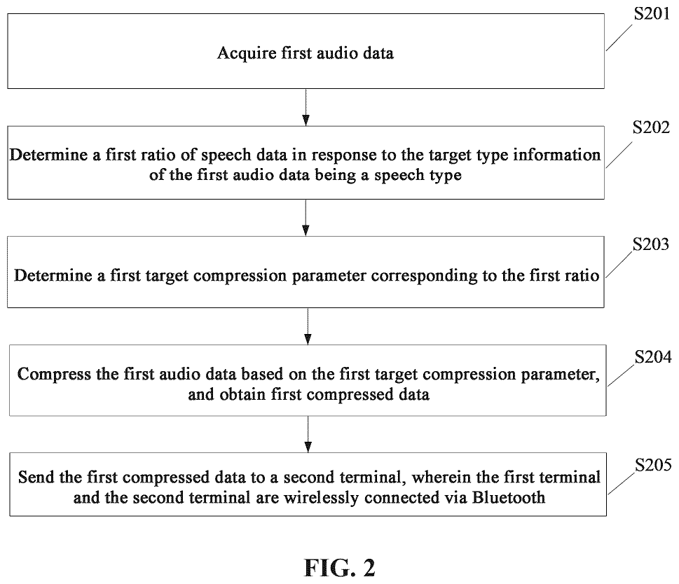

Referring to FIG. 2, FIG. 2 illustrates a second flow chart of an audio data processing method according to the present disclosure. The audio data processing method is applied to a first terminal. As shown in FIG. 2, the method comprises the following steps:
S201: acquiring first audio data.

Reference may be made to the above depictions of step S101 in the embodiment shown in FIG. 1 for the specific implementation of step S201. Detailed depictions will not be presented any more here.

The audio data may be periodically collected, and the audio data collected in each period may be regarded as the first audio data corresponding to the period.
S202: determining a first ratio of the audio data in response to the target type information of the first audio data being a speech type.
S203: determining a first target compression parameter corresponding to the first ratio.

In the present embodiment, the first terminal may first determine target type information corresponding to the first audio data. The target type information corresponding to the first audio data may be determined using a preset audio classification algorithm provided in the first terminal. The target type information indicates whether the first audio data is of a speech type or of a non-speech type.

It may be appreciated that the speech-type first audio data may comprise speech data only, or comprise both speech data and non-speech data. For example, first audio data with a 20 ms duration may comprise non-speech data with a duration in a range of 0-10 ms and speech data with a duration in range of 10 ms-20 ms.

For the first audio data collected at any one sampling period, the first terminal may determine the first ratio of speech data in the first audio data.

The first ratio may be greater than a first preset threshold and less than or equal to 1. Illustratively, the first preset threshold here may comprise 30%, for example.

As an implementation, the first audio data may comprise audio data of more than two frames; for each frame of audio data, an audio data type corresponding to the frame of audio data may be determined, and then the first ratio of speech data in the first audio data is determined according to the audio data type of each frame in the first audio data. Illustratively, if the first audio data comprises 6 frames of audio data, wherein the audio data type of 4 frames of audio data is a speech type, the first ratio of speech data in the first audio data is about 67%.

As another implementation, the first audio data is sent to an audio classification algorithm, and a first score of the first audio data belonging to the speech type and a second score of the first audio data belonging to the non-speech type may be determined using the audio classification algorithm. The first ratio of the speech data may be determined according to the first score and the second score.

For example, if the first score of the first audio data belonging to the human speech obtained according to the audio classification algorithm is 70%, and the second score of the first audio data belonging to non-human speech obtained according to the audio classification algorithm is 30%, the first score 70% may be taken as the first ratio of the human speech.

A first mapping relationship between the ratio of the speech data and the compression parameter may be preset. After the first ratio of the speech data in the first audio data is determined, a first target compression parameter may be determined based on the first mapping relationship and the first ratio. The first target compression parameter comprises a first target compression ratio. The larger the first ratio is, the smaller the first target compression ratio is.

As one implementation, compression parameters respectively corresponding to a plurality of speech data ratio intervals may be preconfigured, and the plurality of speech data ratio intervals and the compression parameters respectively corresponding to the speech data ratio intervals may be stored in association. After the first ratio of the speech data in the first audio data is determined, a target speech data ratio interval corresponding to the first ratio may be determined, and then a compression parameter stored in association with the target speech data ratio interval is taken as the first target compression parameter.

Illustratively, the speech data here is human speech data, a first ratio of the human speech data may be determined in the first audio data, and then the first target compression parameter for the human speech data may be determined based on the first ratio of the human speech data.
S204: compressing the first audio data based on the first target compression parameter to obtain first compressed data.

After the first target compression parameters is obtained, the first audio data may be compressed to obtain the first compressed data.
S205: sending the first compressed data to a second terminal, wherein the first terminal and the second terminal are wirelessly connected via Bluetooth.

In the present embodiment, when the first audio data is of the speech type, the first ratio corresponding to the speech data is determined, the first target compression parameter is determined according to the first ratio, and the first audio data is compressed according to the first target compression parameter. Thus, the first target compression parameters corresponding to the first audio data of the speech type acquired at different time may be different, so that the compression of the speech-type audio data can be achieved according to a dynamic compression ratio. Compressing the speech-type first audio data according to the dynamic compression parameter may, on the one hand, effectively control a loudness fluctuation of the speech data through the dynamic compression ratio to make the speech more balanced, and on the other hand, may facilitate increasing the compression ratio with respect to the audio-type audio data and further reducing the size of the compressed audio data because the first target compression parameter is determined according to the first ratio.

In some implementations of the audio data processing method shown in FIG. 1 and FIG. 2, the method further comprises the following steps:
firstly, determining a second ratio of non-speech data in response to the target type information being a non-speech type;
secondly, determining a second target compression parameter corresponding to the second ratio.
finally, compressing the first audio data based on the second target compression parameter to obtain first compressed data.

In these implementations, the first terminal may first determine target type information corresponding to the first audio data. Illustratively, the first audio data may be classified using a preset audio classification algorithm to obtain a first score of the first audio data belonging to the speech type and a second score of the first audio data belonging to the non-speech type. If the second score is greater than the first score, the first audio data is of the non-speech type.

If the first audio data is of the non-speech type, a second ratio of the non-speech data in the first audio data is determined.

The second ratio may be greater than a second preset threshold and less than or equal to 1. Illustratively, the second preset threshold here may be, for example, 50%.

As an implementation, a second mapping relationship between the ratio of the non-speech data and the compression parameters of the non-speech data may be preset; after the second ratio is determined, a second target compression parameter corresponding to the second ratio may be determined according to the above second mapping relationship.

The second target compression parameter comprises a compression ratio. The compression ratio may be determined according to the second mapping relationship described above.

As an implementation, compression parameters respectively corresponding to a plurality of non-speech data ratio intervals may be preconfigured, and the plurality of non-speech data ratio intervals and the compression parameters respectively corresponding to the non-speech data ratio intervals may be stored in association. After the second ratio of the non-speech data in the first audio data is determined, a target non-speech data ratio interval corresponding to the second ratio may be determined, and then a compression parameter stored in association with the target non-speech data ratio interval is taken as the second target compression parameter corresponding to the second ratio.

Illustratively, the non-speech here is ambient sound, the second ratio of the ambient sound data may be determined in the first audio data, and then the second target compression parameter of the ambient sound data may be determined based on the second ratio. The second target compression parameter may be determined based on the second ratio.

In the present embodiment, when the first audio data is of the non-speech type, the second ratio corresponding to the non-speech data is determined, the second target compression parameter is determined according to the second ratio, and the first audio data is compressed according to the second target compression parameter. Thus, the compression parameters corresponding to the audio data of the non-speech type acquired at different time may be different.

This may achieve the compression of the non-speech type audio data according to a dynamic compression ratio, and facilitate further reducing the size of the compressed data.

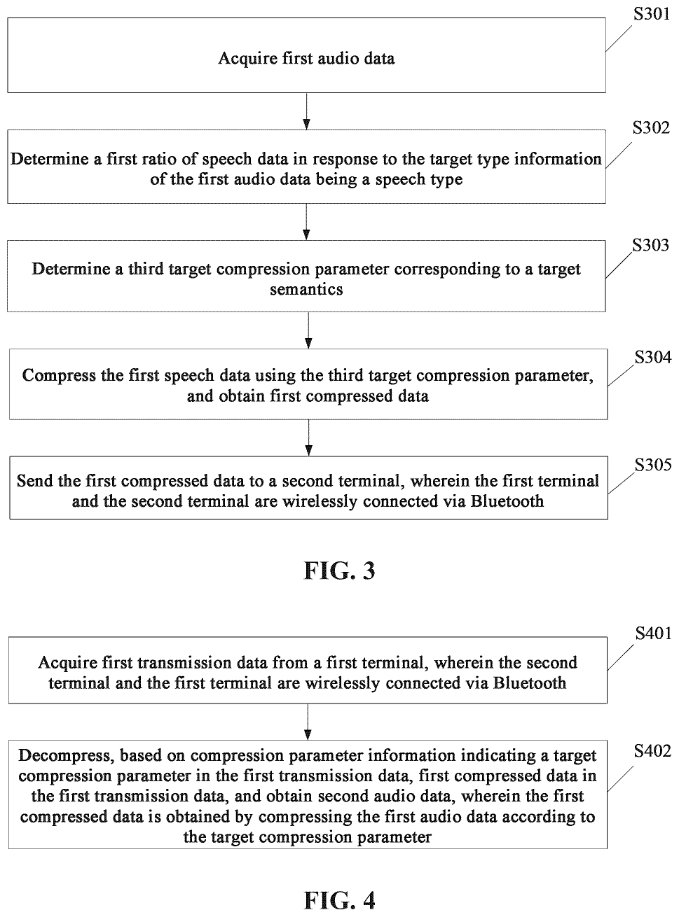

Reference is further made to FIG. 3 which illustrates a third flow chart of an audio data processing method according to the present disclosure. The method is applied to a first terminal. As shown in FIG. 3, the method comprises the following steps:
S301: acquiring first audio data.

Reference may be made to the above depictions of step S101 in the embodiment shown in FIG. 1 for the specific implementation of step S301. Detailed depictions will not be presented any more here.
S302: in response to target type information corresponding to the first audio data being a speech type, parsing the first audio data to determine a target semantics of the first audio data.
S303: determining a third target compression parameter corresponding to the target semantics.
S304: compressing the first speech data using the third target compression parameter to obtain first compressed data.

In the present embodiment, the first terminal may first determine target type information corresponding to the first audio data. The target type information corresponding to the first audio data may be determined using a preset audio classification algorithm provided in the first terminal. The target type information indicates whether the first audio data is of a speech type or a non-speech type.

In some implementations, the first audio data may be sent to the audio classification algorithm, and whether the first audio data is of the speech type or of the non-speech type may be determined using the audio classification algorithm.

If the first audio data is of the speech type, the semantics of the first audio data may be parsed.

In some implementations, the above step S302 comprises:
identifying a preset keyword in the first audio data, and determining the target semantics according to the preset keyword; or
performing semantic understanding on the first audio data, and determining the target semantics according to a semantic understanding result.

In some application scenarios, the preset keyword in the first audio data may be identified, and the target semantics may be determined based on the preset keyword.

The preset keyword here may be a preset word characterizing a certain semantics, such as a word for waking up a target application, or a word for indicating to close the target application, etc. The preset keyword here includes a self-defined wake-up word for the target application (e.g., a speech assistant), an ending keyword for ending the interaction, etc.

In these application scenarios, the first audio data is first converted into a text, and one or more preset keywords are matched in the text. The target semantics of the first audio data is determined according to a successfully-matched target preset keyword.

In these application scenarios, the target semantics of the first audio data may be quickly determined by determining the semantics of the first audio data through the preset keyword included in the first audio data.

In some application scenarios, semantic understanding may be performed on the first audio data, and the target semantics may be determined based on the semantic understanding result.

In these application scenarios, the first audio data may be converted to a text, and then semantic understanding is performed according to the text. For example, the target semantics of the first audio data is obtained by steps such as performing word segmentation on the text, part of speech tagging, named entity recognition, syntax parsing and semantic parsing.

As an example, the text corresponding to the first audio data may be input to a pre-trained semantic recognition model, and target semantics corresponding to the first audio data may be output by the semantic recognition model.

Different target semantics may correspond to different third target compression parameters. The third target compression parameter may include a compression ratio. For example, if the target semantics of the first audio data is waking up the target application, the first audio data needs to be transmitted to the second terminal quickly to get a response quickly. Therefore, the first audio data may be compressed using a larger compression ratio, and the resultant amount of data of the first compressed data is small, so that the first compressed data may be quickly transmitted to the second terminal.

As another example, the target semantics of the first audio data is instructing the target application to reply to a given question. To enable the target application to accurately reply to the above problem, the first audio data needs to be transmitted to the target application with less loss, so that the first audio data may be compressed with a smaller compression ratio.
S305: transmitting the first compressed data to a second terminal, wherein the first terminal and the second terminal are wirelessly connected via Bluetooth.

In the present example, it is described that the target semantics of the speech-type first audio data is determined, a third target compression parameter is determined according to the target semantics, and the first audio data is compressed according to the third target compression parameter. This helps the target application to achieve a fast response or an accurate reply to the first audio data according to the semantics.

In some implementations of the audio data processing method provided by the embodiments shown in FIG. 1, FIG. 2 and FIG. 3, the method further comprises the following steps:

Building first transmission data comprising the first compressed data according to a custom data transmission protocol, and sending the first transmission data to the second terminal, wherein the first transmission data further comprises at least one of compression parameter information indicating a target compression parameter, speech audio start time information and speech audio end time information.

In some application scenarios, the compression parameter information includes target type information of the first audio data. The target type information indicates whether the first audio data is of a speech type or a non-speech type. In this implementation, the compression parameters corresponding to the speech type or the non-speech type may be respectively stored in the second terminal in advance.

In one example, the compression parameter information comprises a target compression parameter corresponding to the first audio data.

In another example, the compression parameter information may further comprise the target type information and the target compression parameter.

Setting the compression parameter information in the first transmission data helps the second terminal to decompress the first transmission data according to the compression parameter information.

The speech audio start time information may be time information with respect to a start time point, where the start time point may be a start time of an initial first audio data.

Similarly, the speech audio end time information may also be time information with respect to the above-mentioned start time point.

In these implementations, the second terminal is facilitated to extract speech data from the first compressed data for parsing by means of the speech audio start time information and the speech audio end time information in the first transmitted data.

In some embodiments, there is no encapsulated data in the first transmission data.

After the target compression parameter is obtained, the first audio data may be compressed in an OPUS compression format to obtain the first compressed data. The first audio data is compressed in the OPUS compression format to obtain the first compressed data without encapsulated data, thereby further reducing the size of the first transmission data.

In some implementations of the audio data processing method provided by the embodiments shown in FIG. 1, FIG. 2 and FIG. 3, the method further comprises the following steps:
transmitting one or more of the following to the second terminal based on the custom data transmission protocol:
a sampling rate, a frame length, a number of channels, a packet interval, a supported packet length, and a supported compression ratio.

In an embodiment, one or more of the above data may be transmitted to the second terminal via the custom data transmission protocol prior to acquiring the first audio data. One or more of the above data may also be transmitted with the first transmission data.

The transmitting the above data to the second terminal helps the second terminal to decompresses the first transmission data according to the above data.

Referring to FIG. 4, FIG. 4 illustrates a flow chart of an audio data processing method according to the present disclosure. The audio data processing method is applied in a second terminal, and the method comprises the following steps:
S401: acquiring first transmission data from a first terminal, wherein the second terminal is wirelessly connected to the first terminal via Bluetooth.
S402: decompressing first compressed data in the first transmission data based on compression parameter information indicating a target compression parameter in the first transmission data to obtain second audio data, wherein the first compressed data is obtained by compressing the first audio data using the target compression parameter.

The second terminal may be a mobile terminal or a fixed terminal supporting a Bluetooth communication connection. The mobile terminal may be, for example, a mobile phone, a notebook computer, a Pad, etc. The fixed terminal may be, for example, a desktop computer or the like.

The first terminal may be a wearable device and may be, for example, a headset, a smart bracelet, smart glasses, a smart watch, etc.

The first terminal may send the first transmission data to the second terminal. The first transmission data comprises the first compressed data. The first transmission data further comprises the compression parameter information. The target compression parameter corresponding to the first compression data may be determined according to the above-compression parameter information.

The second terminal may decompress the first compressed data after determining the target compression parameter.

Reference may be made to the depictions in the embodiments shown in FIG. 1 through FIG. 3 for the steps performed by the first terminal. Detailed depictions will not be presented any more herein.

In some embodiments, the first audio data is collected by the first terminal; and/or the target type information comprises a speech type or a non-speech type.

In these embodiments, an audio data collecting device, such as a microphone, may be provided in the first terminal. The audio data collection device may periodically collect the audio data. The first audio data is collected by the first terminal, and the first terminal compresses and transmits the collected first audio data to the second terminal in real time so that the second terminal responds to the first audio data quickly.

The corresponding target type information of the first audio data comprises a speech type or a non-speech type. The speech type includes a human speech, and the non-speech type includes an ambient sound.

The target compression parameters corresponding to the speech-type first audio data and the non-speech type first audio data respectively may be different, which helps reduce the amount of data of the compressed audio data on the premise of ensuring that the speech signal has a small loss, and helps achieve fast transmission of the audio data between the first terminal and the second terminal.

In some embodiments, the target compression parameter is related to the target type information corresponding to the first audio data, and the first transmission data comprises the first compressed data resulting from the compression of the first audio data via the target compression parameter.

In these embodiments, the target compression parameter is related to the target type information of the first audio data. The target type information indicates whether the first audio data is of a speech type or a non-speech type. That is, the target compression parameters corresponding to different types of first audio data are different.

The target compression parameter comprises a compression ratio. The compression ratio corresponding to the speech-type first audio data is smaller than that corresponding to the non-speech type first audio data, thereby reducing the size of the total compressed audio data of the audio stream.

In some embodiments, the first transmission data further comprises at least one of speech audio start time information and speech audio end time information.

The speech audio start time information may be time information with respect to a start time point, where the start time point may be a start time of an initial first audio data.

Similarly, the speech audio end time information may also be time information with respect to the above start time point.

In these implementations, the second terminal is facilitated to extract speech data from the first compressed data for parsing by means of the speech audio start time information and the speech audio end time information in the first transmitted data.

In some embodiments, second transmission data is acquired from the first terminal based on the custom data transmission protocol, the second transmission data further comprises one or more of the following:
a sampling rate, a frame length, a number of channels, a packet interval, a supported packet length, and a supported compression ratio.

In an embodiment, one or more of the above data may be transmitted to the second terminal via the custom data transmission protocol prior to acquiring the first audio data. One or more of the above data may also be transmitted with the first transmission data.

The second terminal decompresses the first transmission data according to one or more items of the above data.

In some embodiments, there is no encapsulated data in the first transmission data. The first audio data may be compressed in an OPUS compression format. The first audio data may be compressed in the OPUS compression format to obtain the first compressed data without encapsulated data, thereby further reducing the size of the first transmission data

In some implementations, the compression parameter information in step S402 comprises the target type information of the first audio data, the target type information indicates whether the first audio data is of the speech type or the non-speech type. In this implementation, the compression parameters corresponding to the speech type or the non-speech type may respectively be stored in the second terminal in advance. After the target type information is received, if the target type information indicates the speech type, the target compression parameter corresponding to the speech type is acquired from the locally-stored compression parameter. If the target type information indicates the non-speech type, the target compression parameter corresponding to the non-speech type is acquired from the locally-stored compression parameter.

In some implementations, the compression parameter information comprises the target compression parameter corresponding to the first audio data.

In some embodiments, the method further comprises: transmitting the second audio data to a target application on the second terminal, and the target application generates a response to the second audio data.

In these embodiments, the target application may be run in the second terminal. The target application is used for information interaction with a user using the first terminal device.

The target application may generate a response according to the second audio data. The response comprises an audio response and/or a text response.

In these embodiments, the response to the second audio data is generated by the target application, thereby enabling a human-computer interaction between the user and the target application, and facilitating the user to obtain a corresponding service from the target application.

In some implementations, the response is generated by the target application performing semantic understanding on the second audio data according to a semantic understanding result; wherein the response comprises an answer audio and/or an answer text.

In these implementations, the target application may perform semantic understanding on the second audio data after receiving the second audio data. For example, the target application may invoke a natural language semantic understanding model to perform semantic understanding on the second audio data to obtain the semantic understanding result. The answer audio and/or answer text is generated according to the semantic understanding result.

In some examples, the target application is connected to a network server, and the target application transmits the second audio data to the network server for semantic understanding.

In these examples, various natural language processing models may be provided in the network server, and the natural language processing models may convert the input second audio data into a text, then perform semantic understanding according to the text, and then output the semantic understanding result. The above network server may send the semantic understanding result output by the natural language processing model to the target application, and the target application may generate the answer audio and/or answer text according to the semantic understanding result.

In some application scenarios, the target application may generate the answer audio according to the semantic understanding result, and transmit the answer audio to the first terminal via the second terminal for playing, so that the user may hear the answer audio via the first terminal.

In some application scenarios, the target application may also generate the answer text according to the semantic understanding result and present the answer text in a presentation interface of the target application. The user may thus view the answer text in the second terminal.

In these implementations, the second audio data is sent to the target application via the second terminal, and the response to the second audio data is generated by the target application, thereby achieving the interaction between the user and the target application via the first terminal, and providing convenience to the user in obtaining information via the target application.

In the present embodiment, the second terminal acquires the first transmission data from the first terminal, and decompresses the first compressed data in the first transmission data according to the compression parameter information in the first transmission data to obtain the second audio data, wherein the first compression data is obtained by compressing the first audio data according to the target compression parameter. The first transmission data has a small amount of data, so that the first transmission data may be quickly acquired from the first terminal in order to quickly respond to the first audio data.

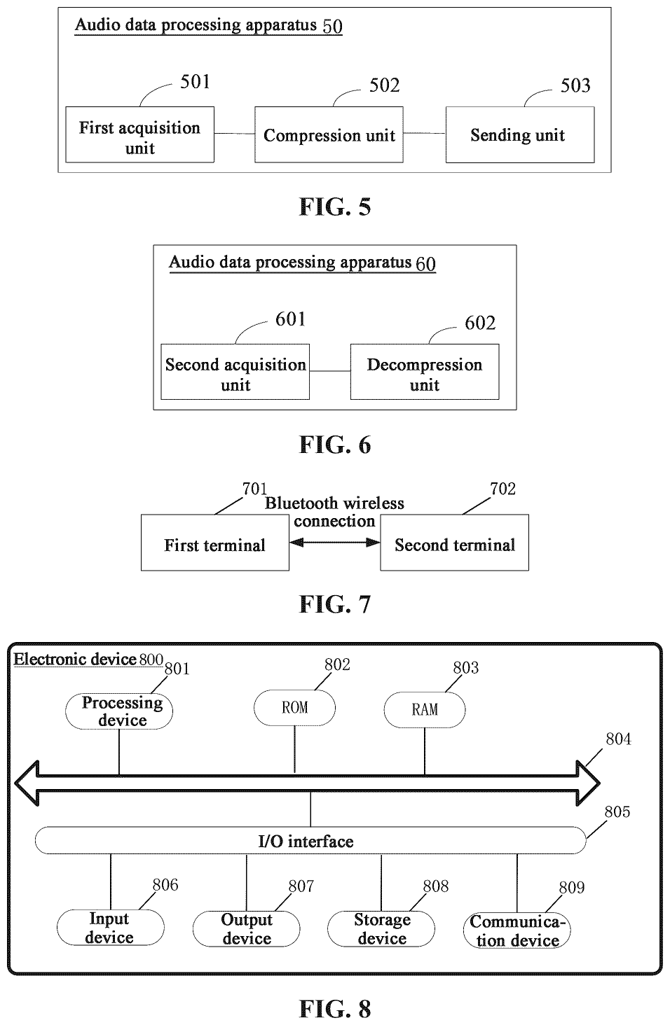

FIG. 5 illustrates a block diagram of an audio data processing apparatus according to an embodiment of the present disclosure, corresponding to the above audio data processing method of the embodiment shown in FIG. 1. For ease of illustration, only portions related to the embodiments of the present disclosure are shown. Referring to FIG. 5, an apparatus 50 comprises: a first acquisition unit 501, a compression unit 502 and a sending unit 503, wherein
the first acquisition unit 501 is configured to acquire first audio data;
the compression unit 502 is configured to determine a target compression parameter according to target type information corresponding to the first audio data, and compress the first audio data based on the target compression parameter to obtain first compressed data; wherein the target type information comprises a speech type or a non-speech type;
the sending unit 503 is configured to send the first compressed data to a second terminal, wherein the first terminal and the second terminal are wirelessly connected via Bluetooth.

In some embodiments, the compression unit 502 is further configured to:
determine a first ratio of speech data in response to the target type information being the speech type;
determine a first target compression parameter corresponding to the first ratio;
compress the first audio data based on the first target compression parameter.

In some embodiments, the compression unit 502 is further configured to:
determine a second ratio of non-speech data in response to the target type information being the non-speech type;
determine a second target compression parameter corresponding to the second ratio;
compress the first audio data based on the second target compression parameter.

In some embodiments, the compression unit 502 is further configured to:
in response to the target type information being the speech type, parse the first audio data to determine a target semantics of the first audio data;
determine a third target compression parameter corresponding to the target semantics;
compress the first speech data using the third target compression parameter.

In some embodiments, the compression unit 502 is further configured to:
identify a preset keyword in the first audio data, and determine the target semantics according to the preset keyword; or
perform semantic understanding on the first audio data, and determine the target semantics according to a semantic understanding result.

In some embodiments, the apparatus 50 further comprises a classification unit (not shown in the figures) configured to:
classify the first audio number based on a preset audio classification algorithm;
determine the target type information of the first audio data according to a classification result.

In some embodiments, the speech type comprises a human speech, and the non-speech type comprises an ambient sound.

In some embodiments, the target compression parameter comprises a compression ratio, wherein the compression ratio corresponding to the speech-type audio data is smaller than that corresponding to the non-speech type audio data.

In some embodiments, the sending unit 503 is further configured to:
build first transmission data comprising the first compressed data according to a custom data transmission protocol, and send the first transmission data to the second terminal, wherein the first transmission data further comprises at least one of compression parameter information indicating the target compression parameter, speech-type audio start time information and speech-type audio end time information.

In some embodiments, the sending unit 503 is further configured to send one or more of the following to the second terminal based on the custom data transmission protocol:
a sampling rate, a frame length, a number of channels, a packet interval, a supported packet length and a supported compression ratio.

In some embodiments, there is no encapsulated data in the first transmission data.

FIG. 6 illustrates a block diagram of an audio data processing apparatus according to an embodiment of the present disclosure, corresponding to the above audio data processing method of the embodiment shown in FIG. 4. For ease of illustration, only portions related to the embodiment of the present disclosure are shown. Referring to FIG. 6, an apparatus 60 comprises: a second acquisition unit 601 and a decompression unit 602, wherein,
the second acquisition unit 601 is configured to acquire first transmission data from a first terminal, wherein a second terminal and the first terminal are wirelessly connected via Bluetooth;
the decompression unit 602 is configured to decompress first compressed data in the first transmission data based on compression parameter information indicating a target compression parameter in the first transmission data to obtain second audio data, wherein the first compressed data is obtained by compressing the first audio data according to the target compression parameter.

In some embodiments, the apparatus 60 further comprises an answer unit (not shown in the figure) configured to transmit the second audio data to a target application on the second terminal, the target application generating a response to the second audio data.

In some embodiments, the response is generated by the target application performing semantic understanding on the second audio data according to a semantic understanding result; wherein the response comprises an answer audio and/or an answer text.

In some embodiments, the target application is connected to a network server, and the target application transmits the second audio data to the network server for semantic understanding.

In some embodiments, the target compression parameter is related to the target type information corresponding to the first audio data, and the first transmission data comprises the first compressed data resulting from the compression of the first audio data via the target compression parameter.

In some embodiments, the first audio data is collected by the first terminal; and/or the target type information comprises a speech type or a non-speech type.

In some embodiments, the first transmission data further comprises at least one of speech audio start time information and speech audio end time information.

In some embodiments, second transmission data is acquired from the first terminal based on the custom data transmission protocol, and the second transmission data further comprises one or more of the following:
a sampling rate, a frame length, a number of channels, a packet interval, a supported packet length and a supported compression ratio.

In some embodiments, there is no encapsulated data in the first transmission data.

Referring to FIG. 7, FIG. 7 is a block diagram of an audio data processing system according to the present disclosure. As shown in FIG. 7, the audio data processing system comprises a first terminal and a second terminal, wherein,
the first terminal comprises a data acquisition device, a data processing device and a first Bluetooth device, wherein the data acquisition device acquires first audio data; the data processing device determines a target compression parameter according to target type information corresponding to the first audio data, and compresses the first audio data based on the target compression parameter to obtain first compressed data; wherein the target type information comprises a speech type or a non-speech type; the first Bluetooth device sends the first compressed data to the second terminal;
the second terminal comprises a second Bluetooth device and a second data processing device, where the second Bluetooth device acquires first transmission data from the first terminal; the second data processing device decompresses the first compressed data in the first transmission data based on compression parameter information indicating the target compression parameter in the first transmission data to obtain second audio data.
the data acquisition device in the first terminal may acquire the first audio data. Reference may be made to the above depictions of step S101 in the embodiment shown in FIG. 1 for the specific implementation of the acquisition of the first audio data by the data acquisition device.

Reference may be made to relevant portions of the embodiments shown in FIG. 1 through FIG. 3 for how the data processing device of the first terminal determines the target compression parameter according to the target type information corresponding to the first audio data, and compresses the first audio data according to the target compression parameter to obtain the first compressed data. Detailed depictions will not be presented any more here.

The first terminal may be a wearable device, such as a headset. The second terminal may be a mobile terminal, such as a mobile phone, a notebook, a Pad, etc. In order to implement the above embodiments, embodiments of the present disclosure further provide an electronic device.

Referring to FIG. 8, FIG. 8 is a block diagram of an electronic device 800 according to an embodiment of the present disclosure. The electronic device 800 may be a terminal device or server. The terminal device may include, but is not limited to a mobile terminal such as a mobile phone, a notebook computer, a Portable Android Device (PAD), a Portable Media Player (PMP), an in-vehicle terminal (e.g., an in-vehicle navigation terminal) and a stationary terminal such as a digital TV, a desktop computer, and the like. The electronic device shown in FIG. 8 is only an example, and should not impose any limitation on the function and scope of use of the embodiments of the present disclosure.

As shown in FIG. 8, the electronic device 800 may include a processing device (e.g., a central processor, a graphics processor, etc.) 801 that may perform various appropriate actions and processes based on a program stored in a Read-Only Memory (ROM) 802 or a program loaded from a storage device 408 to A Random Access Memory (RAM) 803. In the RAM 803, there further store various programs and data needed for operations of the electronic device 800. The processing device 801, ROM 802 and RAM 803 are connected to one another via a bus 804. An input/output (I/O) interface 805 is also connected to the bus 804.

Usually, the following components may be connected to the I/O interface 808: an input device 806 such as a touch screen, a touchpad, a keyboard, a mouse, a camera, a microphone, an accelerometer and a gyroscope; an output device 807 such as a Liquid Crystal Display (LCD), a speaker and a vibrator; a storage device 808 such as a magnetic tape and a hard disk; and a communication device 809 which may allow the electronic device 800 to perform wireless or wired communication with other devices to exchange data. Although FIG. 8 shows the electronic device 800 having various device, it should be appreciated that not all of the illustrated device are required to be implemented or provided. More or fewer device may alternatively be implemented or provided.

In particular, according to embodiments of the present disclosure, the process described above with reference to the flowchart may be implemented as a computer software program. For example, embodiments of the present disclosure include a computer program product comprising a computer program carried on a computer readable medium, the computer program containing program code for performing the method illustrated in the flowchart. In such an embodiment, the computer program may be downloaded and installed from the network via the communication device 809, or installed from the storage device 808, or installed from the ROM 802. When the computer program is executed by the processing device 801, the above functions defined in the method of the embodiments of the present disclosure are performed.

It needs to be appreciated that the above computer readable storage medium in the present disclosure may be a computer readable signal medium or a computer readable storage medium or any combination of the computer readable signal medium and the computer readable storage medium. The computer-readable storage medium can be, for example, but not limited to, an electrical, magnetic, optical, electromagnetic, infrared, or semiconductor system, apparatus or device, or a combination of any of the above. More specific examples of the computer readable storage medium may include, but are not limited to an electrically connected, portable computer magnetic disk, hard disk, Random Access Memory (RAM), Read Only Memory (ROM), Erasable Programmable Read Only Memory (EPROM or flash memory), optical fiber, portable Compact Disk Read Only Memory (CD-ROM), optical storage device, magnetic storage device having one or more lead wires, or any suitable combinations of the above. In the present disclosure, a computer-readable storage medium may be any tangible medium that contains or stores a program that a program for use by or in connection with an instruction execution system, apparatus, or device. However, in the present disclosure, the computer-readable signal medium may include a data signal propagated in baseband or as part of a carrier wave with the computer-readable program code embodied thereon. Such propagated data signals may take a variety of forms, including but not limited to electromagnetic signals, optical signals, or any suitable combination of the foregoing. A computer-readable signal medium can also be any computer-readable medium other than the computer-readable storage medium, which can communicate, propagate, or transport a program for use by or in connection with an instruction execution system, apparatus, or device. Program code embodied on a computer readable medium may be transmitted using any appropriate medium, including but not limited to wireline, optical fiber cable, RF, etc., or any suitable combination of the foregoing.

The above-mentioned computer-readable medium may be included in the above-mentioned electronic device; or may exist alone without being assembled into the electronic device.

The above-mentioned computer-readable medium carries one or more programs which, when executed by the electron device, causes the electronic device to perform the methods shown in the above embodiments.

Computer program code for carrying out operations for aspects of the present disclosure may be written in one or more programming languages or combinations thereof, the programming languages including an object oriented programming language such as Java, Smalltalk, C++ or the like and conventional procedural programming languages, such as the “C” programming language or assembly language or similar programming languages. The program code may execute entirely on the user's computer, partly on the user's computer, as a stand-alone software package, partly on the user's computer and partly on a remote computer or entirely on the remote computer or server. In the situations involving the remote computer, the remote computer may be connected to the user's computer through any type of network, including a Local Area Network (LAN) or a Wide Area Network (WAN), or may be connected to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code that contains one or more executable instructions for implementing specified logic functions. It should also be noted that, in some alternative implementations, the functions annotated in the blocks may occur out of the order noted in the figures. For example, two blocks shown in succession may, in fact, be executed substantially concurrently, or the blocks may sometimes be executed in the reverse order, depending upon the functionality involved. It is also noted that each block of the block diagrams and/or flowcharts, and combinations of blocks in the block diagrams and/or flowcharts, can be implemented in dedicated hardware-based systems that perform the specified functions or operations, or can be implemented in a combination of dedicated hardware and computer instructions.

The units involved in the embodiments of the present disclosure may be implemented in software or hardware. The names of the units do not constitute a limitation of the units themselves under certain circumstances.

The functions described herein above may be performed, at least in part, by one or more hardware logic components. For example, without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the subject matter described herein, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, hard drive, Random-Access Memory (RAM), Read-Only Memory (ROM), Erasable Programmable Read-Only Memory (EPROM or flash memory), optical fiber, a portable compact Disc Read-Only Memory (CD-ROM), an optical storage device, a magnetic storage device, or any suitable combination of the foregoing.

In a first aspect, according to one or more embodiments of the present disclosure, there is provided an audio data processing method, comprising: acquiring first audio data;
determining a target compression parameter according to target type information corresponding to the first audio data, and compressing the first audio data based on the target compression parameter to obtain first compressed data; wherein the target type information comprises a speech type or a non-speech type;
sending the first compressed data to a second terminal, wherein the first terminal and the second terminal are wirelessly connected via Bluetooth.

According to one or more embodiments of the present disclosure, the determining a target compression parameter according to target type information corresponding to the first audio data, and compressing the first audio data based on the target compression parameter comprises:
determining a first ratio of speech data in response to the target type information being the speech type;
determining a first target compression parameter corresponding to the first ratio;
compressing the first audio data based on the first target compression parameter.

According to one or more embodiments of the present disclosure, the determining a target compression parameter according to target type information corresponding to the first audio data, and compressing the first audio data based on the target compression parameter comprises:
determining a second ratio of non-speech data in response to the target type information being the non-speech type;
determining a second target compression parameter corresponding to the second ratio;
compressing the first audio data based on the second target compression parameter.

According to one or more embodiments of the present disclosure, the determining a target compression parameter according to target type information corresponding to the first audio data, and compressing the first audio data based on the target compression parameter comprises:
in response to the target type information being the speech type, parsing the first audio data to determine a target semantics of the first audio data;
determining a third target compression parameter corresponding to the target semantics;
compressing the first speech data using the third target compression parameter.

According to one or more embodiments of the present disclosure, the parsing the first audio data to determine a target semantics of the first audio data comprises:
identifying a preset keyword in the first audio data, and determining the target semantics according to the preset keyword; or
performing semantic understanding on the first audio data, and determining the target semantics according to a semantic understanding result.

According to one or more embodiments of the present disclosure, the method further comprises:
classifying the first audio number based on a preset audio classification algorithm;
determining the target type information of the first audio data according to a classification result.

According to one or more embodiments of the present disclosure, the speech type comprises a human speech, and the non-speech type comprises an ambient sound.

According to one or more embodiments of the present disclosure, the target compression parameter comprises a compression ratio, wherein

the compression ratio corresponding to the speech-type audio data is smaller than that corresponding to the non-speech type audio data.

According to one or more embodiments of the present disclosure, the sending the first compressed data to a second terminal comprises:
building first transmission data comprising the first compressed data according to a custom data transmission protocol, and sending the first transmission data to the second terminal, wherein the first transmission data further comprises at least one of compression parameter information indicating the target compression parameter, speech audio start time information and speech audio end time information.

According to one or more embodiments of the present disclosure, the method further comprises: sending one or more of the following to the second terminal based on the custom data transmission protocol:
a sampling rate, a frame length, a number of channels, a packet interval, a supported packet length and a supported compression ratio.

According to one or more embodiments of the present disclosure, there is no encapsulated data in the first transmission data.

In a second aspect, according to one or more embodiments of the present disclosure, there is provided an audio data processing method, comprising:
acquiring first transmission data from a first terminal, wherein a second terminal and the first terminal are wirelessly connected via Bluetooth;
decompressing first compressed data in the first transmission data based on compression parameter information indicating a target compression parameter in the first transmission data to obtain second audio data, wherein the first compressed data is obtained by compressing the first audio data according to the target compression parameter.

According to one or more embodiments of the present disclosure, the method further comprises:
transmitting the second audio data to a target application on the second terminal, the target application generating a response to the second audio data.

According to one or more embodiments of the present disclosure, the response is generated by the target application performing semantic understanding on the second audio data according to a semantic understanding result; wherein the response comprises an answer audio and/or an answer text.

According to one or more embodiments of the present disclosure, the target application is connected to a network server, and the target application transmits the second audio data to the network server for semantic understanding.

According to one or more embodiments of the present disclosure, the target compression parameter is related to the target type information corresponding to the first audio data, and the first transmission data comprises the first compressed data resulting from the compression of the first audio data via the target compression parameter.

According to one or more embodiments of the present disclosure, the first audio data is collected by the first terminal; and/or the target type information comprises a speech type or a non-speech type.

According to one or more embodiments of the present disclosure, the first transmission data further comprises at least one of speech audio start time information and speech audio end time information.

According to one or more embodiments of the present disclosure, second transmission data is acquired from the first terminal based on the custom data transmission protocol, and the second transmission data further comprises one or more of the following:
a sampling rate, a frame length, a number of channels, a packet interval, a supported packet length and a supported compression ratio.

According to one or more embodiments of the present disclosure, there is no encapsulated data in the first transmission data.

In a third aspect, according to one or more embodiments of the present disclosure, there is provided an audio data processing apparatus provided in a first terminal, the apparatus comprising:
a first acquisition unit configured to acquire first audio data;
a compression unit configured to determine a target compression parameter according to target type information corresponding to the first audio data, and compress the first audio data based on the target compression parameter to obtain first compressed data; wherein the target type information comprises a speech type or a non-speech type;
a sending unit configured to send the first compressed data to a second terminal, wherein the first terminal and the second terminal are wirelessly connected via Bluetooth.

According to one or more embodiments of the present disclosure, the compression unit is further configured to:
determine a first ratio of speech data in response to the target type information being the speech type;
determine a first target compression parameter corresponding to the first ratio;
compress the first audio data based on the first target compression parameter.

According to one or more embodiments of the present disclosure, the compression unit is further configured to:
determine a second ratio of non-speech data in response to the target type information being the non-speech type;
determine a second target compression parameter corresponding to the second ratio;
compress the first audio data based on the second target compression parameter.

According to one or more embodiments of the present disclosure, the compression unit is further configured to:
in response to the target type information being the speech type, parse the first audio data to determine a target semantics of the first audio data;
determine a third target compression parameter corresponding to the target semantics;
compress the first speech data using the third target compression parameter.

According to one or more embodiments of the present disclosure, the compression unit is further configured to:
identify a preset keyword in the first audio data, and determine the target semantics according to the preset keyword; or
perform semantic understanding on the first audio data, and determine the target semantics according to a semantic understanding result.

According to one or more embodiments of the present disclosure, the apparatus further comprises a classification unit configured to:
classify the first audio number based on a preset audio classification algorithm;
determine the target type information of the first audio data according to a classification result.

According to one or more embodiments of the present disclosure, the speech type comprises a human speech, and the non-speech type comprises an ambient sound.

According to one or more embodiments of the present disclosure, the target compression parameter comprises a compression ratio, wherein
the compression ratio corresponding to the speech-type audio data is smaller than that corresponding to the non-speech type audio data.

According to one or more embodiments of the present disclosure, the sending unit is further configured to:
build first transmission data comprising the first compressed data according to a custom data transmission protocol, and send the first transmission data to the second terminal, wherein the first transmission data further comprises at least one of compression parameter information indicating the target compression parameter, speech-type audio start time information and speech-type audio end time information.

According to one or more embodiments of the present disclosure, the sending unit is further configured to send one or more of the following to the second terminal based on the custom data transmission protocol:
a sampling rate, a frame length, a number of channels, a packet interval, a supported packet length and a supported compression ratio.

According to one or more embodiments of the present disclosure, there is no encapsulated data in the first transmission data.

In a fourth aspect, according to one or more embodiments of the present disclosure, there is provided an audio data processing apparatus provided in a second terminal, the apparatus comprising:
a second acquisition unit configured to acquire first transmission data from a first terminal, wherein the second terminal and the first terminal are wirelessly connected via Bluetooth;
a decompression unit configured to decompress first compressed data in the first transmission data based on compression parameter information indicating a target compression parameter in the first transmission data to obtain second audio data.

According to one or more embodiments of the present disclosure, the apparatus further comprises an answer unit configured to transmit the second audio data to a target application on the second terminal, the target application generating a response to the second audio data.

According to one or more embodiments of the present disclosure, the response is generated by the target application performing semantic understanding on the second audio data according to a semantic understanding result; wherein the response comprises an answer audio and/or an answer text.

According to one or more embodiments of the present disclosure, the target application is connected to a network server, and the target application transmits the second audio data to the network server for semantic understanding.

According to one or more embodiments of the present disclosure, the target compression parameter is related to the target type information corresponding to the first audio data, and the first transmission data comprises the first compressed data resulting from the compression of the first audio data via the target compression parameter.

According to one or more embodiments of the present disclosure, the first audio data is collected by the first terminal; and/or the target type information comprises a speech type or a non-speech type.

According to one or more embodiments of the present disclosure, the first transmission data further comprises at least one of speech audio start time information and speech audio end time information.

According to one or more embodiments of the present disclosure, second transmission data is acquired from the first terminal based on the custom data transmission protocol, and the second transmission data further comprises one or more of the following:
a sampling rate, a frame length, a number of channels, a packet interval, a supported packet length and a supported compression ratio.

According to one or more embodiments of the present disclosure, there is no encapsulated data in the first transmission data.

In a fifth aspect, according to one or more embodiments of the present disclosure, there is provided an audio data processing system, comprising a first terminal and a second terminal; the first terminal and the second terminal being wirelessly connected via Bluetooth;
the first terminal comprises a data acquisition device, a data processing device and a first Bluetooth device, wherein the data acquisition device acquires first audio data; the data processing device determines a target compression parameter according to target type information corresponding to the first audio data, and compresses the first audio data based on the target compression parameter to obtain first compressed data; wherein the target type information comprises a speech type or a non-speech type; the first Bluetooth device sends the first compressed data to the second terminal;
the second terminal comprises a second Bluetooth device and a second data processing device, where the second Bluetooth device acquires first transmission data from the first terminal; the second data processing device decompresses the first compressed data in the first transmission data based on compression parameter information indicating the target compression parameter in the first transmission data to obtain second audio data.

According to one or more embodiments of the present disclosure, the first terminal comprises a wearable device;
the second terminal comprises a mobile terminal.

In a sixth aspect, according to one or more embodiments of the present disclosure, there is provided an electronic device comprising: at least one processor and a memory;
the memory stores computer-executable instructions;
the at least one processor executes the computer-executable instructions stored in the memory to cause the at least one processor to perform the methods in the first aspect, the second aspect and various possible designs of the first aspect and second aspect.

In a seventh aspect, according to one or more embodiments of the present disclosure, there is provided a computer-readable storage medium having stored therein computer-executable instructions that, when executed by a processor, implement the audio data processing methods in the first aspect, the second aspect, and various possible designs of the first aspect and the second aspect.

In an eighth aspect, according to one or more embodiments of the present disclosure, there is provided a computer program product comprising a computer program which, when executed by a processor, implement the methods in the first aspect, the second aspect, and various possible designs of the first aspect and the second aspect.

What are described above are only preferred embodiments of the present disclosure and illustration of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, the technical solutions formed by the above-mentioned technical features or other technical solutions formed by any combination of their equivalent features. For example, a technical solution is formed by replacing the above features with the technical features disclosed in the present disclosure (but not limited to) with similar functions.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter disclosed herein or of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

I/We claim:

1. An audio data processing method applied to a first terminal, the method comprising:
acquiring first audio data;
determining a target compression parameter according to target type information corresponding to the first audio data, and compressing, based on the target compression parameter, the first audio data to obtain first compressed data, wherein the target type information comprises a speech type or a non-speech type; and
sending the first compressed data to a second terminal, wherein the first terminal and the second terminal are wirelessly connected via Bluetooth.

2. The method according to claim 1, wherein determining a target compression parameter according to target type information corresponding to the first audio data, and compressing, based on the target compression parameter, the first audio data comprises:
determining a first ratio of speech data in response to the target type information being the speech type;
determining a first target compression parameter corresponding to the first ratio; and
compressing the first audio data based on the first target compression parameter.

3. The method according to claim 1, wherein determining a target compression parameter according to target type information corresponding to the first audio data, and compressing, based on the target compression parameter, the first audio data comprises:
determining a second ratio of non-speech data in response to the target type information being the non-speech type;
determining a second target compression parameter corresponding to the second ratio; and
compressing the first audio data based on the second target compression parameter.

4. The method according to claim 1, wherein the determining a target compression parameter according to target type information corresponding to the first audio data, and compressing, based on the target compression parameter, the first audio data comprises:
in response to the target type information being the speech type, parsing the first audio data, and determining target semantics of the first audio data;
determining a third target compression parameter corresponding to the target semantics; and
compressing the first speech data using the third target compression parameter.

5. The method according to claim 4, wherein parsing the first audio data, and determining a target semantics of the first audio data comprises:
identifying a preset keyword in the first audio data, and determining the target semantics according to the preset keyword; or
performing semantic understanding on the first audio data, and determining the target semantics according to a semantic understanding result.

6. The method according to claim 1, wherein the method further comprises:
classifying the first audio data based on a preset audio classification algorithm; and
determining the target type information of the first audio data according to a classification result.

7. The method according to claim 1, wherein the speech type comprises human speech, and the non-speech type comprises ambient sound.

8. The method according to claim 1, wherein the target compression parameter comprises a compression ratio, wherein
the compression ratio corresponding to the speech-type audio data is smaller than that corresponding to the non-speech type audio data.

9. The method according to claim 1, wherein sending the first compressed data to the second terminal comprises:
building first transmission data comprising the first compressed data according to a custom data transmission protocol, and sending the first transmission data to the second terminal, wherein the first transmission data further comprises at least one of: compression parameter information indicating the target compression parameter, speech audio start time information and speech audio end time information.

10. The method according to claim 1, wherein the method further comprises:
sending one or more of the following to the second terminal based on a custom data transmission protocol:
a sampling rate, a frame length, a number of channels, a packet interval, a supported packet length and a supported compression ratio.

11. The method according to claim 1, wherein there is no encapsulated data in the first transmission data.

12. An audio data processing method applied to a second terminal, wherein the method comprises:
acquiring first transmission data from a first terminal, wherein the second terminal and the first terminal are wirelessly connected via Bluetooth; and
decompressing, based on compression parameter information indicating a target compression parameter in the first transmission data, first compressed data in the first transmission data, and obtaining second audio data, wherein the first compressed data is obtained by compressing the first audio data according to the target compression parameter.

13. The method according to claim 12, wherein the method further comprises:
transmitting the second audio data to a target application on the second terminal, and generating a response to the second audio data by the target application.

14. The method according to claim 13, wherein the response is generated by the target application performing semantic understanding on the second audio data according to a semantic understanding result; wherein the response comprises an answer audio and/or an answer text.

15. The method according to claim 14, wherein the target application is connected to a network server, and the target application transmits the second audio data to the network server for semantic understanding.

16. The method according to claim 12, wherein the target compression parameter is related to the target type information corresponding to the first audio data, and the first transmission data comprises the first compressed data resulting from the compression of the first audio data via the target compression parameter.

17. The method according to claim 16, wherein the first audio data is collected by the first terminal; and/or the target type information comprises a speech type or a non-speech type.

18. The method according to claim 16, wherein the first transmission data further comprises at least one of speech audio start time information and speech audio end time information.

19. The method according to claim 12, wherein second transmission data is acquired from the first terminal based on a custom data transmission protocol, and the second transmission data further comprises one or more of the following:
a sampling rate, a frame length, a number of channels, a packet interval, a supported packet length and a supported compression ratio.

20. A non-transitory storage medium containing computer-executable instructions, wherein the computer-executable instructions, when executed by one or more computer processors, are used to cause the one or more computer processors to:
acquire first audio data;
determine a target compression parameter according to target type information corresponding to the first audio data, and compress, based on the target compression parameter, the first audio data to obtain first compressed data, wherein the target type information comprises a speech type or a non-speech type; and
send the first compressed data to a second terminal, wherein the first terminal and the second terminal are wirelessly connected via Bluetooth.
